(19) United States
(12) Patent Application Publication
(10) Pub. No.: US 2010/0232910 A1
(43) Pub. Date: Sep. 16, 2010

(54) INFORMATION PROCESSING APPARATUS, INFORMATION PROCESSING METHOD, PROGRAM, AND STORAGE MEDIUM

(75) Inventor: Nobuyuki Hirai, Port Washington, NY (US)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/720,384

(22) Filed: Mar. 9, 2010

(30) Foreign Application Priority Data
Mar. 13, 2009 (JP) 2009-061682

(51) Int. Cl. B42C 7/00; B65H 39/00

(52) U.S. Cl. 412/6; 270/58.08

(57) ABSTRACT

An apparatus includes an instruction unit configured to give an instruction for executing divided stapling, an acquisition unit configured, when the instruction is given, to acquire a number of staplable sheets, a determination unit configured to determine a location at which the divided stapling is executed based on the acquired number of staplable sheets and a number of sheets necessary for each chapter, and a staple setting unit configured to set a staple attribute for instructing a printing apparatus to execute stapling by using the determined location as a unit of the divided stapling.

### BACKGROUND OF THE INVENTION

1. Field of the Invention

The present invention relates to an information processing apparatus, an information processing method, a program, and a storage medium.

2. Description of the Related Art

An image forming apparatus has been marketed, such as a printer or a copying machine, which can be instructed to print a plurality of copies of a document being edited on an information processing apparatus such as a personal computer (PC) and executing post-processing such as stapling processing on the printed sheet bundle.

In addition, an information processing system has been marketed, which can be designated not only whether to execute stapling processing on the entire print job but also a range of chapters or pages to be stapled of a printing target document. In the above-described system, a user can issue a designation of a partial stapling instruction for instructing whether to execute stapling on each chapter, of a plurality of portions (chapters or pages) of document data.

Japanese Patent Application Laid-Open No. 2003-91380 discusses a system like this, which includes a printing processing apparatus that generates print data according to a partial stapling instruction designated by a user and executes stapling according to the print data.

However, in the method discussed in Japanese Patent Application Laid-Open No. 2003-91380 described above, stapling can be set even if a number of prints exceeding staplable number of sheets is set. Accordingly, in the above-described conventional method, if a staple setting has been set, a sheet bundle of the resulting print product may not be stapled. In this case, a user may not obtain a desired print product.

### SUMMARY OF THE INVENTION

According to an aspect of the present invention, an apparatus includes an instruction unit configured to give an instruction for executing divided stapling, an acquisition unit configured, when the instruction for executing divided stapling is given, to acquire a number of staplable sheets, a determination unit configured to determine a location at which the divided stapling is executed based on the acquired number of staplable sheets and a number of sheets necessary for each chapter, and a staple setting unit configured to set a staple attribute for instructing a printing apparatus to execute stapling by using the determined location as a unit of the divided stapling.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the present invention.

FIG. 1 is a block diagram illustrating an exemplary software configuration of an information processing system according to an exemplary embodiment of the present invention.

FIG. 2 is a block diagram illustrating an exemplary hardware configuration that can implement an information processing system according to an exemplary embodiment of the present invention.

FIG. 3 illustrates an exemplary structure of a book file according to an exemplary embodiment of the present invention.

FIG. 4 is a table illustrating an example of a list of book attributes (document setting information) according to an exemplary embodiment of the present invention.

FIG. 5 illustrates an example of a list of chapter attributes (chapter setting information) according to an exemplary embodiment of the present invention.

FIG. 6 is a table illustrating an example of a list of page attributes (page setting information) according to an exemplary embodiment of the present invention.

FIG. 7 illustrates an example of a user interface (UI) screen displayed, when an existing book file is opened, based on a structure, an attribute, and a content of the book file according to an exemplary embodiment of the present invention.

FIG. 8 illustrates an example of a data structure of a job ticket according to an exemplary embodiment of the present invention.

FIG. 9 illustrates an example of a “document detailed setting” window of a bookbinding application according to an exemplary embodiment of the present invention.

FIG. 10 illustrates an example of a “chapter detailed setting” window of a bookbinding application according to an exemplary embodiment of the present invention.

FIG. 11 illustrates an example of a “page detailed setting” window of a bookbinding application according to an exemplary embodiment of the present invention.

FIG. 12 illustrates an example of a staple setting set via the document detailed setting window of the bookbinding application according to an exemplary embodiment of the present invention.

FIG. 13 illustrates an example of a staple setting set via the chapter detailed setting window of the bookbinding application according to an exemplary embodiment of the present invention.

FIG. 14 illustrates an example of a further detailed format of a paper discharge attribute of the book attribute (document setting information) illustrated in FIG. 4 according to an exemplary embodiment of the present invention.

FIG. 15 illustrates an example of a data structure of paper discharge destination attribute included in a chapter attribute (chapter setting information) according to an exemplary embodiment of the present invention.

FIG. 16 illustrates an example of a “number of staplable sheets” setting dialog of a bookbinding application according to an exemplary embodiment of the present invention.

FIG. 17 is a flow chart illustrating an example of processing for automatically executing a staple setting according to a first exemplary embodiment of the present invention.

FIG. 18 illustrates an example of a list of results of the staple automatic setting processing illustrated in FIG. 17 according to an exemplary embodiment of the present invention.

FIG. 19 is a flow chart illustrating an example of processing for automatically executing a staple setting according to a second exemplary embodiment of the present invention.

FIG. 20 illustrates an example (case 1) of a list of results of the staple automatic setting processing illustrated in FIG. 19 according to an exemplary embodiment of the present invention.

FIG. 21 illustrates an example (case 2) of a list of results of the staple automatic setting processing illustrated in FIG. 19 according to an exemplary embodiment of the present invention.

### DESCRIPTION OF THE EMBODIMENTS

Various exemplary embodiments, features, and aspects of the invention will be described in detail below with reference to the drawings.

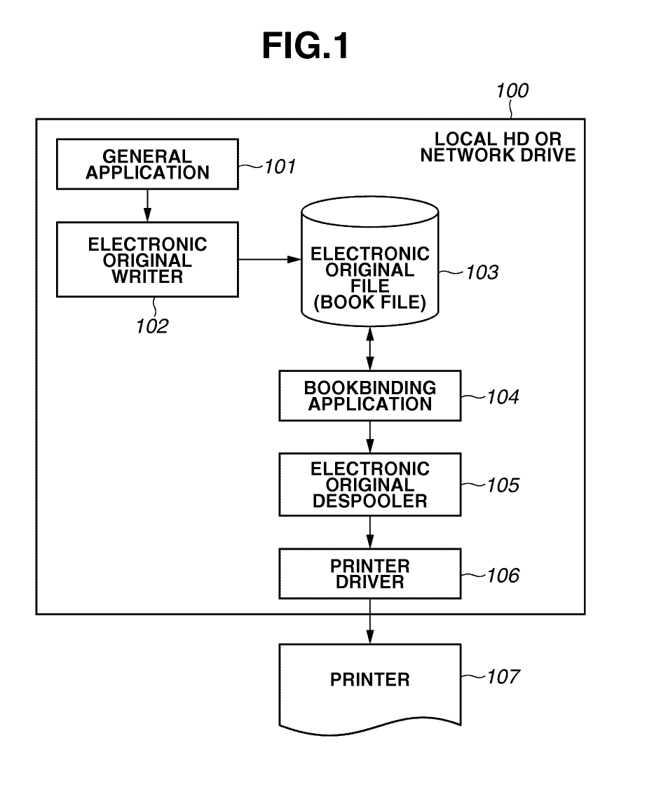

Now, an example of an information processing system according to a first exemplary embodiment of the present invention will be described in detail below with reference to FIGS. 1 through 13. In the information processing system, a data file generated by a general application is converted into an electronic original file by an electronic original writer. A bookbinding application provides a function for editing the electronic original file.

In the present exemplary embodiment, functions of each of the general application, the electronic original writer, the bookbinding application, and an electronic original despooler are separately provided for clearly describing various functions implemented in the information processing system. However, a package to be provided to a user is not limited to this configuration. The functions implemented in the information processing system can be provided as an application or a graphic engine including a combination thereof.

FIG. 1 is a block diagram illustrating an exemplary software configuration of the information processing system according to the present exemplary embodiment. The information processing system is implemented by a host computer 100, which is an exemplary embodiment of an information processing apparatus of the present invention.

A general application 101 is an application program that provides various functions, such as a word processing function, a spreadsheet function, a photo retouch function, a draw or paint function, a presentation function, and a text editing function. The general application 101 has a printing function for an operating system (OS). In printing application data, such as generated document data or image data, the general application 101 utilizes a predetermined interface (a graphic device interface (GDI)), which is provided by the OS.

More specifically, the general application 101 transmits an output command (a “GDI function”) of a predetermined format that is dependent on the OS to an output module of the OS that provides a predetermined interface to print the generated data. After receiving the output command, the output module converts the output command into a format that an output device, such as a printer, can process. Then, the output module outputs the converted command (a device driver interface (DDI) function).

The format that the output device can process may be different according to a type, manufacturer, and a model of the device. Accordingly, a unique device driver for controlling the device is provided to each device. The OS uses the device driver to convert the command, generates print data, and describes it in a job language (JL) to generate a print job. When Windows® of Microsoft Corporation is used as the OS (operating system), a module called GDI corresponds to the output module described above.

An electronic original writer 102 is an improvement of the above-described device driver. The electronic original writer 102 is a software module provided to realize the present information processing system. However, the electronic original writer 102 does not target a specific output device but instead converts the output command into a command of a format that can be processed by a bookbinding application 104 and a printer driver 106. The bookbinding application 104 and the printer driver 106 will be described in detail below.

The format after the conversion (hereinafter referred to as an “electronic original format”) by the electronic original writer 102 may be any format only if each original page can be expressed in a detailed form. Among substantial standard formats, the portable document format (PDF) of Adobe Systems, Inc. and the scalable vector graphics (SVG) format provided by World Wide Web Consortium (W3C), for example, can be employed as the electronic original format.

When the electronic original writer 102 is utilized by the general applications 101, the electronic original writer 102 is designated as a device driver to be used for output before executing printing.

However, an electronic original file just generated by the electronic original writer 102 does not have a complete format as an electronic original file. Therefore, the bookbinding application 104 designates the electronic original writer 102 as a device driver. Application data is converted into an electronic original file under control of the bookbinding application 104.

The bookbinding application 104 completes a new and incomplete electronic original file generated by the electronic original writer 102 as an electronic original file having a format to be described later.

Hereinbelow, a file generated by the electronic original writer 102 is referred to as an “electronic original file” and an electronic original file that has been given a structure by the bookbinding application 104 is referred to as a “book file”. Otherwise, an electronic original file and a book file are collectively referred to as a “document file” (or “document data”).

As described above, by using the electronic original writer 102 as the device, the application data is converted into an electronic original format. The application data is converted into an electronic original format in the unit of a page defined by the general application 101 (hereinafter referred to as a “logical page” or an “original page”).

The converted data of the electronic original format is stored on a storage medium such as a hard disk as an electronic original file (i.e., book file) 103. As the hard disk, a local drive included in the host computer 100 that implements the information processing system according to the present exemplary embodiment can be used. Alternatively, if communication via a network is available, a drive provided on the network can be used as the hard disk.

The bookbinding application 104 provides the user with a function for reading the electronic original file (book file) 103 and editing the read book file 103. However, the bookbinding application 104 does not include a function for editing the content of each page but provides a function for editing the structure of a chapter and a book, which include a page as their minimum unit. A “chapter” and a “book” will be described in detail below.

In printing the book file 103 that has been edited by the bookbinding application 104, the bookbinding application 104 activates an electronic original despooler 105. The electronic original despooler 105 is a program module installed in a computer together with the bookbinding application 104. Further, the electronic original despooler 105 is a module used for outputting drawing data to the printer driver 106 and a printer 107 when a document (book file) utilized by the bookbinding application 104 is printed.

The electronic original despooler 105 reads a designated book file 103 from the hard disk. Further, the electronic original despooler 105 generates an output command compliant with the output module of the OS to print each page in the format described in the read book file 103 and outputs the generated output command to the output module. In outputting the output command to the output module, the printer driver 106 of the printer 107, which is used as an output device, is designated as a device driver.

The output module converts the output command received by using the designated printer driver 106 of the printer 107 into a device command that the printer 107 can interpret and execute. Then, the device command is transmitted to the printer 107. The printer 107 prints an image according to the received device command on a print sheet.

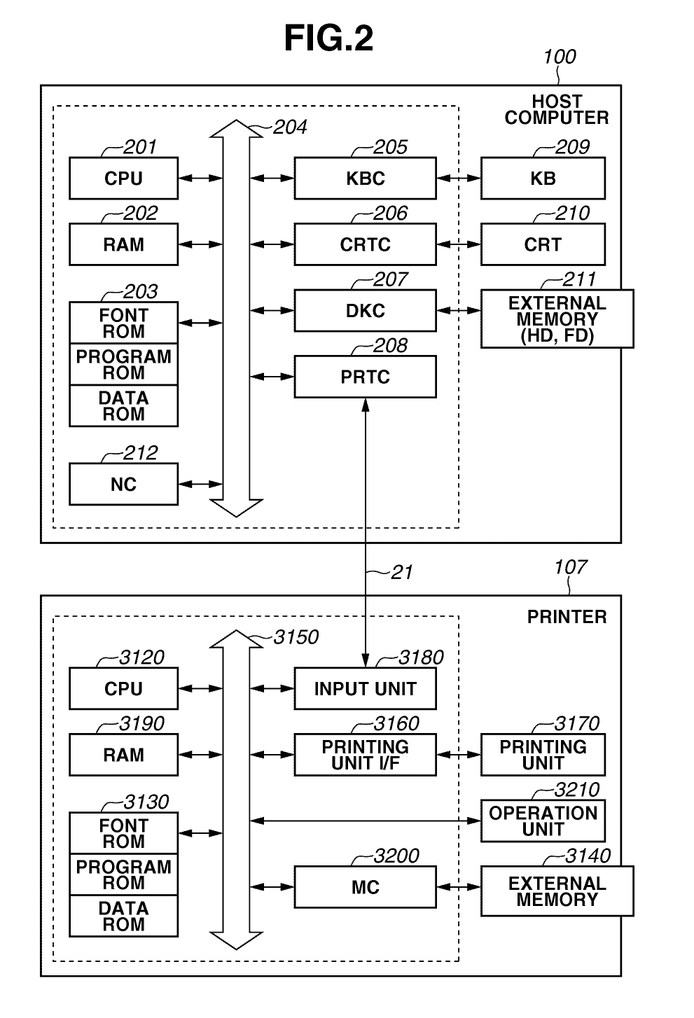

FIG. 2 illustrates an exemplary hardware configuration of the information processing system according to the present exemplary embodiment.

Referring to FIG. 2, the host computer 100 includes a central processing unit (CPU) 201. The CPU 201 executes processing according to a program, such as a document processing program stored on a program read-only memory (ROM) of a ROM 203 (e.g., font ROM, program ROM, data ROM) or an external memory (i.e., HD, FD) 211. The processing executed by the CPU 201 includes processing of a document that mixedly includes components, such as a diagram, an image, a character, or a table (including a spreadsheet) . Further, the CPU 201 controls an entire operation of devices connected to a system bus 204 of the host computer 100.

The program ROM of the ROM 203 or the external memory 211 stores a program, such as an OS, which is a control program for the CPU 201. A font ROM of the ROM 203 or the external memory 211 stores data, such as font data that is used in processing a document. A data ROM of the ROM 203 or the external memory 211 stores various data used in executing various processing, such as the document processing. A random access memory (RAM) 202 functions as a main memory and a work area of the CPU 201.

A keyboard controller (KBC) 205 controls a key input from a keyboard (KB) 209 and a command input from a pointing device (not illustrated). A cathode ray tube (CRT) controller (CRTC) 206 controls display on a CRT display (CRT) 210. A disk controller (DKC) 207 controls access to/from the external memory 211 such as a hard disk (HD) and a floppy disk (FD).

The external memory 211 stores various programs and data, such as a boot program, various applications, font data, a user file, a file to be edited, and a printer driver.

A printer controller (PRTC) 208 is connected to the printer 107 via a predetermined interactive interface 21 and controls a communication with the printer 107. A network controller (NC) 212 is connected to a network and controls communication between the host computer 100 and other apparatuses on the network.

The CPU 201 rasterizes an outline font on a display information RAM, which is provided on the RAM 202, to provide a graphic user interface (GUI). Thus, “what you see is what you get” (WYSIWIG) on the CRT 210 is implemented. In addition, the CPU 201 opens various registered windows according to a command issued by a user by using a mouse cursor (not illustrated) on the CRT 210 to execute various types of data processing.

In executing printing, the user opens a window (operation screen) for performing a print setting and can execute settings of the printer 107 and a printing method for the printer driver including selection of a print mode. The printer 107 includes a central processing unit (CPU) 3120, which controls the operation of the printer 107.

In addition, the printer CPU 3120 outputs an image signal (output information) to a printing unit (printer engine) 3170 according to a control program stored on a ROM (including font ROM, program ROM, and data ROM) 3130 or an external memory 3140. The printing unit 3170 is connected to a system bus 3150 via a printing unit I/F 3160.

A program ROM of the ROM 3130 stores a program, such as a control program for the CPU 3120. A font ROM of the ROM 3130 stores the data such as font data for generating the above-described output information. When a printer that does not include an external memory 3140 such as an HD is used, a data ROM of the ROM 3130 stores information utilized by the host computer 100.

The printer CPU 3120 can communicate with the host computer 100 via an input unit 3180. The printer CPU 3120 can notify various pieces of information about the printer 107 to the host computer 100. A random access memory (RAM) 3190 functions as a main memory and a work area of the printer CPU 3120. A memory capacity of the RAM 3190 can be expanded with an optional RAM, which can be connected to an expansion port (not illustrated).

The RAM 3190 is used as an output information rasterization area, an environmental data storage area, and a non-volatile random access memory (NVRAM). Access to/from the external memory 3140, which is an HD or an integrated circuit (IC) card, is controlled by a memory controller (MC) 3200. The external memory 3140, which is connected as an optional memory, stores the font data, an emulation program, form data, or the like.

An operation panel (i.e., operation unit) 3210 includes components, such as operation switches that implement various operations on the printer 107 and a light-emitting diode (LED) indicator.

The number of the external memories 3140 is not limited to one. More specifically, a plurality of external memories 3140 may be provided and a plurality of optional font cards, in addition to the built-in font, and a plurality of external memories storing a program for interpreting a printer control language (PCL) of different language systems can be connected. In addition, an NVRAM (not illustrated) may be provided to store printer mode setting information from the operation unit 3210.

Before describing the details of the bookbinding application 104, a data format of a book file is described at first.

A book file has a 3-layer structure as a book made of paper sheets. More specifically, a top layer “book” corresponds to one book, and can include a definition of an attribute of the entire document. An intermediate layer “chapter” corresponds to a chapter of a paper book. Each “chapter” can include a definition of an attribute of each thereof. A bottom layer “page” corresponds to each page defined by the application program. Each page can include an attribute of each page. One book can include a plurality of chapters, while one chapter can include a plurality of pages.

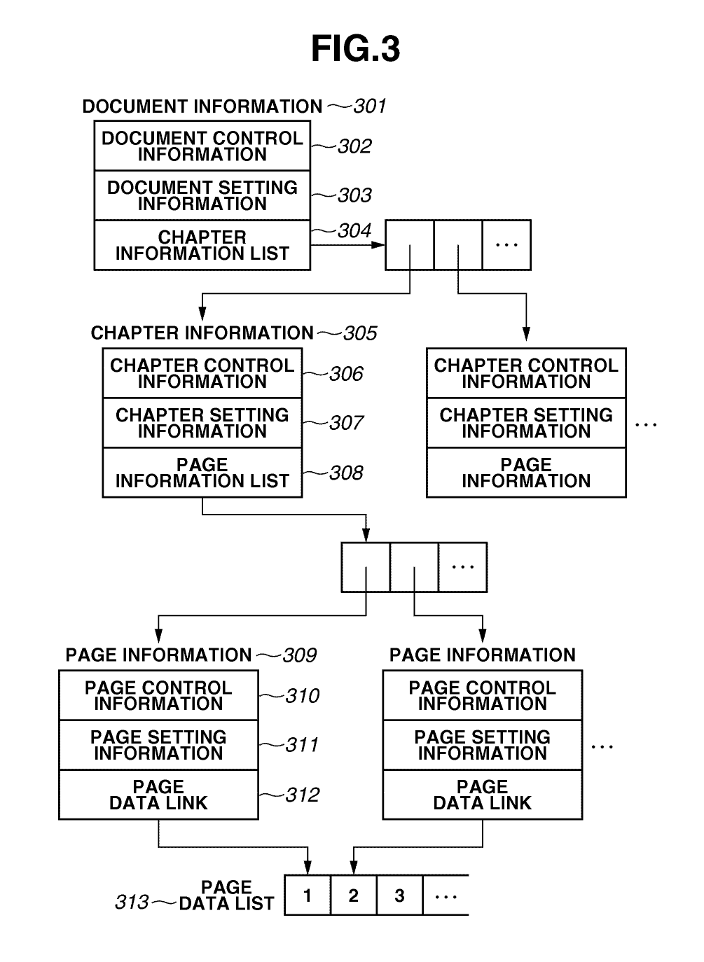

FIG. 3 illustrates an exemplary data format of a book file according to the present exemplary embodiment. Each of a book, chapter, and page of the book file illustrated in FIG. 3 is indicated with a node corresponding thereto. One book file includes one book. A book and a chapter are concepts that define the structure of the book. Accordingly, a book and a chapter include a defined attribute value and a link to a lower layer as an entity thereof.

A page includes data of each page output by the application program as its entity. Accordingly, a page includes its attribute value, the entity of a page of an original (hereinafter referred to as an “original page data”), and a link to each original page data. A printed page to be output on a print sheet such as a paper medium may include a plurality of original pages. This structure is not indicated by the link but indicated as an attribute of each layer of book, chapter, and page.

In the example illustrated in FIG. 3, a “book” is described as a “document” in general because it is not necessary that a book file is one integrated book.

Referring to FIG. 3, a document includes document information 301 on its top layer. The document information 301 includes three portions 302 through 304. Document control information 302 stores information such as a path name in a file system of a document file. Document setting information 303 stores layout information such as a page layout and setting information about a function of the printing apparatus such as a stapling function. The document setting information 303 corresponds to an attribute of a book.

A chapter information list 304 stores an aggregate of chapters constituting a document as a list. The list stores chapter information 305. The chapter information 305 includes three broad portions 306 through 308.

Chapter control information 306 stores information about a name of a chapter. Chapter setting information 307 stores information about a page layout and stapling, which are set uniquely to the chapter. The chapter setting information 307 corresponds to an attribute of a chapter. As described above, each chapter includes the chapter setting information 307. Accordingly, a document having an intricate layout whose first chapter has a 2-up layout while whose other chapters have a 4-up layout, for example, can be generated.

A page information list 308 stores an aggregate of original pages constituting each chapter as a list. The page information list 308 includes page information data 309.

The page information data 309 includes three portions 310 through 312. Page control information 310 stores information such as a page number indicated as a tree structure. Page setting information 311 stores information such as page rotational angle and page layout information. The page setting information 311 corresponds to an attribute of an original page. Page data link information 312 is original data corresponding to a page.

In the example illustrated in FIG. 3, the page information data 309 does not directly include the original data but include the page data link information 312 only. The actual original data is stored in the page data list 313.

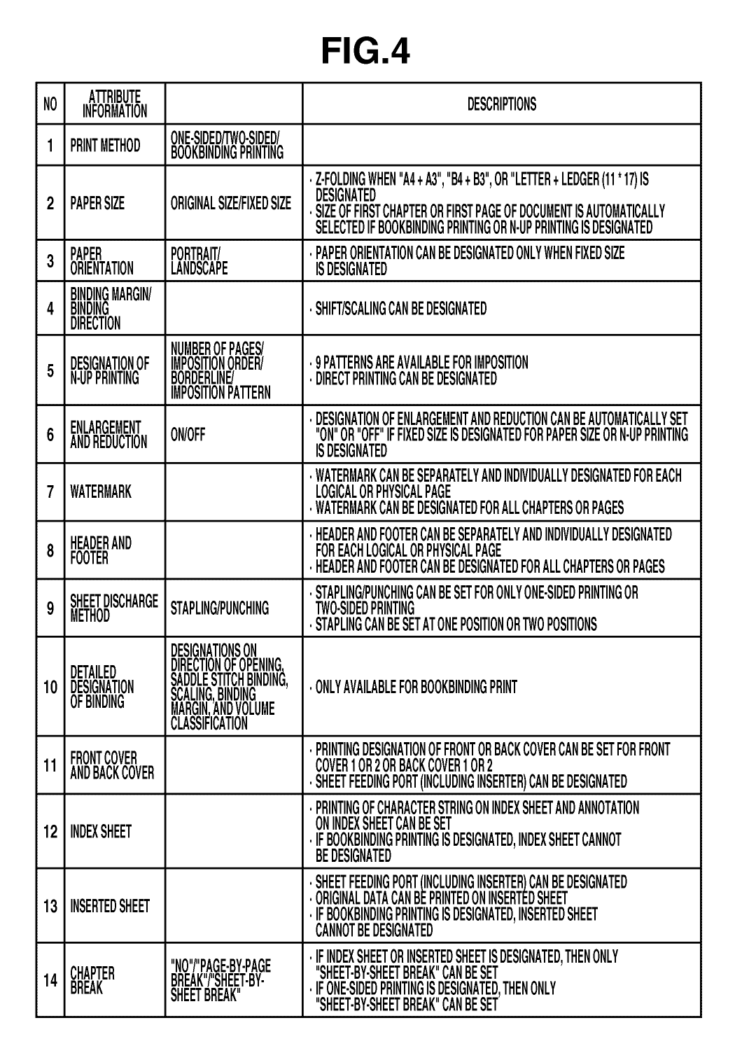

FIG. 4 illustrates an example of a book attribute (the document setting information 303) according to the present exemplary embodiment. In general, an item that can be defined in duplication with a lower layer, an attribute value of the lower layer is prioritized over its upper layer. Accordingly, as for an item that is included only in a book attribute, a value defined in the book attribute becomes valid for the entire book.

On the other hand, the item that can be defined in duplication with a lower layer can be used as a default value of a case where no definition is provided in the lower layer. In the example illustrated in FIG. 4, each item does not necessarily correspond to only one setting item. That is, an item can include a plurality of related setting items.

Referring to FIG. 4, the following six items can be included in a book attribute as unique items, namely, “printing method”, “bookbinding details”, “front cover/back cover”, “index sheet”, “inserted sheet”, and “chapter break”. The items can be defined in a book. For the attribute “printing method”, a value of three setting items, namely, “one-sided printing”, “two-sided printing”, and “bookbinding printing”, can be designated.

“Bookbinding printing” is a method for printing in which a printed sheet bundle including a separately designated number of sheets is two-folded and bound into a book, for example. With respect to the attribute “bookbinding details”, if bookbinding is designated as a layout method, then an item such as the direction of opening, the number of sheets of a bundle, and the like, can be designated.

The attribute “front cover/back cover” includes designation of using a front/back cover sheet and the content to be printed on the cover sheet when printing an electronic original file to be bound into a book.

The attribute “index sheet” includes designation of inserting a tabbed index sheet as a chapter break, which is separately set on the printing apparatus, and designation of the content to be printed on the index portion (tab). The attribute “index sheet” becomes enabled if an inserter having a function for inserting a sheet provided separately from the printing sheet at a desired position of a sheet bundle is provided to the printing apparatus or if a plurality of sheet feed cassettes can be used. The same applies to the attribute “inserted sheet”.

The attribute “inserted sheet” includes designation of inserting a sheet supplied from the inserter or the sheet feed cassette as a chapter break. Further, if it is designated to insert such a sheet, the attribute “inserted sheet” can include designation of a sheet feed source.

The attribute “chapter break” can designate, for a chapter break, whether to use a new sheet, whether to use a new page to be printed, or whether not to apply a particular operation for the chapter break. In the case of one-sided printing, the chapter break is set in the same format regardless of whether a new sheet or a new page to be printed is designated. On the other hand, in two-sided printing, if it is designated to use a new sheet for a chapter break, different two consecutive chapters are not printed on a same sheet while if it is designated to use a new page to be printed for a chapter break, different two consecutive chapters may be printed on the front side and the back side of one sheet, respectively.

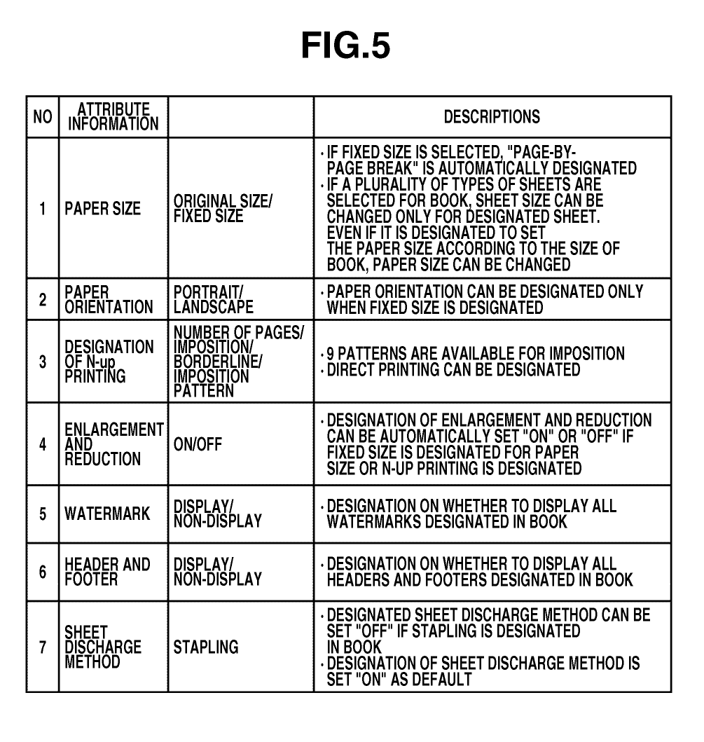

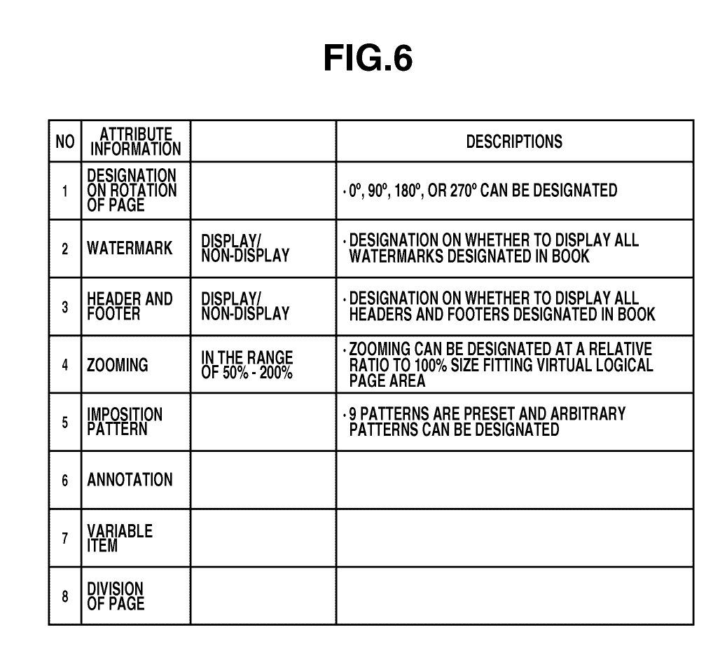

FIG. 5 illustrates an example of a chapter attribute (the chapter setting information 307) according to the present exemplary embodiment. FIG. 6 illustrates an example of a page attribute (the page setting information 311) according to the present exemplary embodiment. The relationship between the chapter attribute and the page attribute is similar to the relationship between the book attribute and an attribute of a lower layer.

In the chapter attribute, no item unique to a chapter is defined and all items are the same as those defined in the book attribute. Accordingly, if the definition in the chapter attribute differs from the definition in the book attribute, then the parameter value defined in the chapter attribute is generally prioritized and used.

Only five items, such as the paper size, the paper orientation, designation of N-up printing, enlargement/reduction, and a sheet discharge method, are defined in common to the book attribute and the chapter attribute. Among the five common items, the attribute “N-up printing” designates the number of original pages to be printed on one page. For the type of the N-up layout, “1×1”, “1×2”, “2×2”, “3×3”, or “4×4”, for example, can be designated.

The attribute “sheet discharge method” designates whether to execute stapling on the discharged sheet. The attribute “sheet discharge method” becomes enabled if the printing apparatus to be used includes the stapling function.

The attributes such as “page rotation”, “zooming”, “imposition”, “annotation”, “page division”, or the like can be defined uniquely to the page attribute. The attribute “page rotation” designates the rotational angle of a page when an original page is imposed on a page to be printed. The attribute “zooming” designates a zooming (enlargement) ratio of the original page. The zooming ratio is a ratio of the size of the original page to the size of a virtual logical page area (100%).

A virtual logical page area refers to an area of one original page when the original page is imposed according to the layout designation such as N-up printing. For example, if the imposition “1×1” is designated, the virtual logical page area corresponds to the area of one printing page. On the other hand, if the imposition “1×2” is designated, the virtual logical page area corresponds to the area of one printing page whose each side is reduced to 70% of its original size.

The attributes “watermark” and “header/footer” are defined in common to the book, the chapter, and the page attributes. A “watermark” refers to information such as an image or a character string, which is designated separately from image data generated by an application and is printed in superimposition therewith.

Each of a header and footer is a watermark printed in a top margin or a bottom margin of each page. An item that can be designated by a variable, namely, information such as a page number or date and time, is provided to the header and the footer.

The contents that can be designated in the watermark attribute and the header/footer attribute are the same in the chapter attribute and the page attribute, but are different in the book attribute. In the book attribute, the content of the watermark and the header/footer can be designated. In addition, in the book attribute, a method for printing the watermark and the header/footer can be designated in the entire book.

On the other hand, in the chapter attribute and the page attribute, it can be designated whether to print the watermark or the header/footer set in the book attribute in the corresponding chapter or page.

A book file has the above-described structure and content. Now, exemplary processing for generating a book file executed by the bookbinding application 104 and the electronic original writer 102 will be described in detail below.

The book file generation processing is implemented as a part of an operation of the bookbinding application 104 for editing a book file.

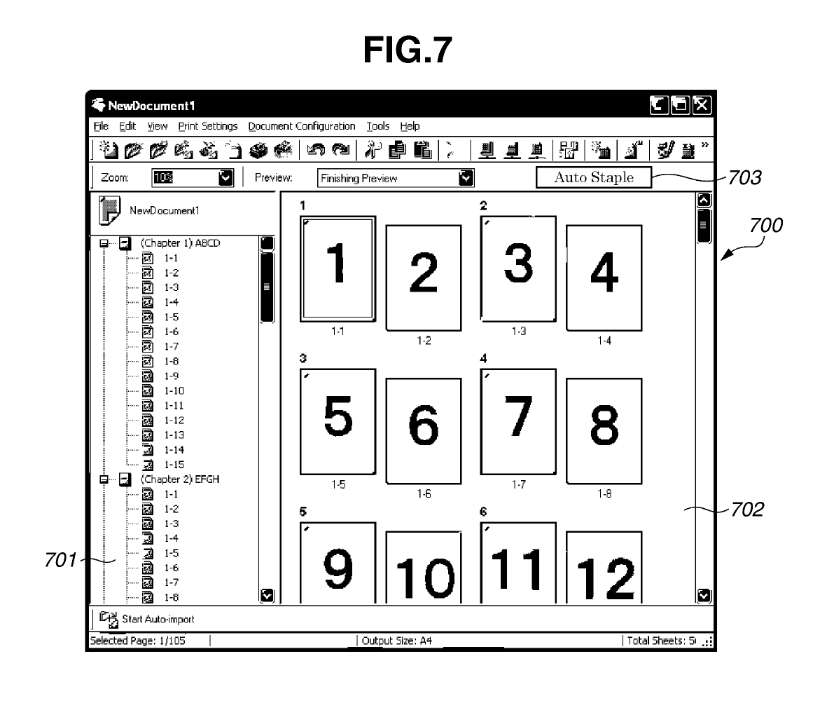

FIG. 7 illustrates an example of a user interface (UI) screen displayed according to the structure, an attribute, and the content of a book file opened by a user according to the present exemplary embodiment. A UI screen 700 includes a tree structure field 701 and a preview field 702. More specifically, the tree structure field 701 displays a chapter of a book and data of each page of a chapter in a tree-like structure, so that a hierarchical structure illustrated in FIG. 3 can be easily recognized by the user.

In FIG. 7, an original page is displayed in the tree structure field 701. The preview field 702 displays the content of a page to be printed as a reduced image. An order of displaying the images is determined according to the structure of the book. The UI screen 700 also includes an “auto staple” button 703. The “auto staple” button 703 can be operated to give an instruction for shifting an operation mode to an automatic staple mode. The automatic staple mode will be described in detail below. The bookbinding application 104 can generate a book file based on the application data in the above-described manner.

The following editing operations can be executed on a chapter and a page of the book file generated in the above-described manner.
(1) Adding a new chapter or page
(2) Deletion
(3) Copying
(4) Cutting
(5) Pasting
(6) Moving
(7) Renaming of chapter
(8) Changing the page number or renaming the page name
(9) Inserting a front cover sheet
(10) Inserting a sheet
(11) Inserting an index sheet
(12) Designating the page layout to each original page

In addition to the operations described above, an operation for canceling the once designated editing operation and an operation for re-designating the once cancelled operation can be executed. By executing the above-described editing functions, editing operations, such as integrating with a plurality of book files, rearranging a chapter or a page within a book file, deleting a chapter or a page from a book file, changing a layout of an original page, and inserting a sheet or an index sheet, can be implemented.

After the above-described editing operation is executed, the result of the operation is applied to the attribute illustrated in FIGS. 4 through 6 or to the structure of the book file. For example, if a blank page is newly added, the blank page is inserted at a designated portion of the chapter. The inserted blank page is handled as an original page.

On the other hand, if the layout of an original page is changed, the content of the change is applied to the attribute, such as the printing method, N-up printing, the front cover/back cover, the index sheet, the inserted sheet, and the chapter break.

A screen displayed during an editing operation and an example of the editing operation according to the present exemplary embodiment will be described in detail below. The book file that is generated and edited in the above-described manner is intended to be finally printed or output. When the user selects a file menu on the UI screen 700, illustrated in FIG. 7, of the bookbinding application and selects “print” from the menu, the book file is printed and output by a designated output device.

In this case, at first, the bookbinding application 104 generates a job ticket based on the currently opened book file and transmits the generated job ticket to the electronic original despooler 105. After receiving the job ticket, the electronic original despooler 105 converts the received job ticket into an output command of the OS, such as a GDI command of Windows®. The electronic original despooler 105 further transmits the converted command to the output module such as a GDI.

The output module generates a command that complies with the type of the device by using a designated printer driver 106 and transmits the generated command to the device. More specifically, a graphic engine of the output module loads the printer driver 106, which is provided for each printing apparatus, from the external memory 211 onto the RAM 202 and sets the output to the printer driver 106.

Then, the output module converts the received GDI function into a DDI function and then outputs the converted DDI function to the printer driver 106. The printer driver 106 converts the received DDI function into a control command that the printer 107 can interpret, such as a page description language (PDL).

The converted printer control command is then output, as print data, to the printer 107 via the system spooler loaded on the RAM 202 by the OS and the interface 21.

In the present exemplary embodiment, a job ticket is data having a structure in which an original page is a minimum unit. The structure of the job ticket defines the layout of the original page on the sheet. Furthermore, one job ticket is issued for each job.

Therefore, in the job ticket, a document node exists in the top layer, which defines the attribute of the entire document, such as the attribute “one-sided printing/two-sided printing”. Below the document node, a sheet node exists, which includes an attribute such as an identifier of a sheet to be used and designation of a sheet feed port of the printer. Each sheet node includes a node of a sheet to be printed on a paper sheet. One “sheet” included in the sheet node corresponds to one paper sheet.

Each “sheet” includes the attribute of a page to be printed (physical page). If one-sided printing is designated, one sheet includes one physical page. On the other hand, if two-sided printing is designated, then one sheet includes two physical pages. Each physical page includes an original page to be provided thereon. In addition, the layout of the original page is included in the attribute of the physical page.

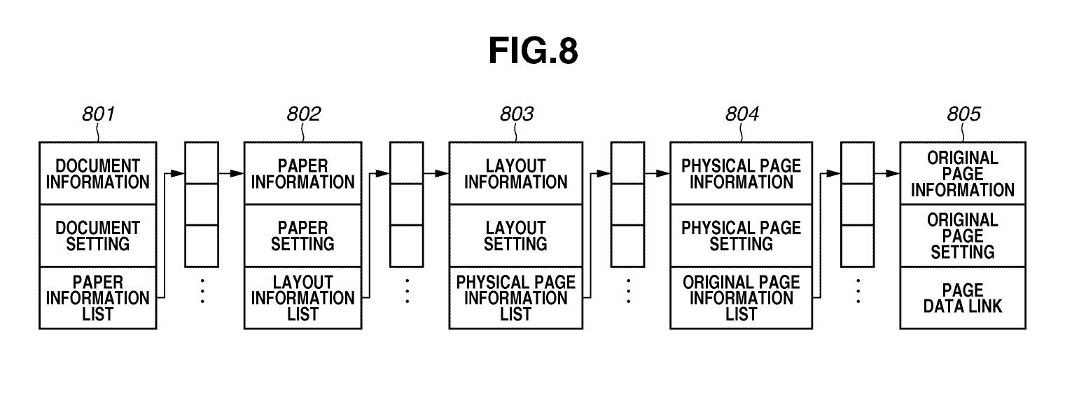

FIG. 8 illustrates an example of a data structure of a job ticket. In print data, a document includes an aggregate of sheets. Each sheet includes two sides of the sheet (the front and the back sides) according to the present exemplary embodiment. Each of the front and the back sides includes an area in which the document is laid out (physical page). Each physical page includes an aggregate of original pages, which is the minimum unit thereof.

Referring to FIG. 8, document data 801 is data corresponding to a document. The document data 801 includes a list of information about the sheets constituting the document (i.e., document information, document setting, and paper information list). Paper information 802 includes information about the sheet (e.g., such as the paper size) and a list of information about a sheet space, which is laid out on the sheet (i.e., sheet layout information).

Sheet layout information 803 includes layout information unique to a sheet space, layout setting and a list of physical page information about the physical page to be imposed on the sheet space (i.e., physical page information list). Physical page information 804 includes physical page information such as the size and the header/footer of the physical page, physical page setting, and a list of original page information, which is information about the original pages constituting the physical page (i.e., original page information list). The electronic original despooler 105 converts the job ticket into the output command to the output module.

As described above, when a book file is opened by the bookbinding application 104, the CPU 201 controls the CRT (display apparatus) 210 via the CRTC 206 to display the UI screen 700 illustrated in FIG. 7.

The tree structure field 701 of the UI screen 700 displays a tree that indicates the structure of the currently opened book (hereinafter referred to as a “target book”). The preview field 702 includes three different display methods that can be designated by the user as desired.

A first display method is an “original view mode”. In the original view mode, the content of the original page data of the target book is reduced and displayed as it is without displaying the layout of the original page in the preview field 702.

A second display method is a “print view mode”. In the print view mode, the original page is displayed in the preview field 702 in a state in which the layout of the original page is reflected.

A third display method is a “simple print view mode”. In the simple print view mode, the content of each original page is not reflected in the display in the preview field 702 and only the layout thereof is reflected.

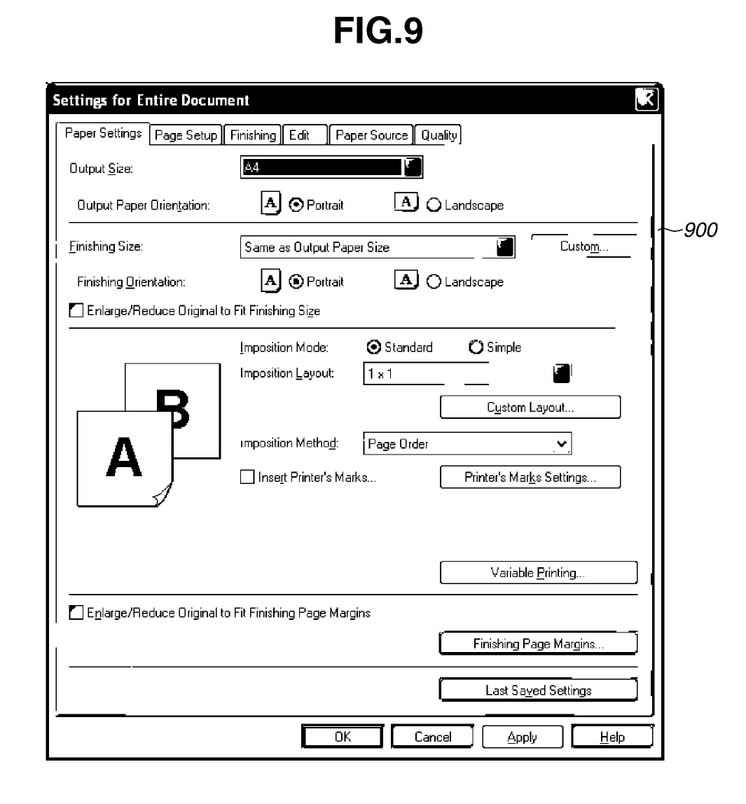

FIG. 9 illustrates an example of a “settings for entire document” window 900 of the bookbinding application 104 according to the present exemplary embodiment. The user can display and set the document setting information 303 via the “settings for entire document” window 900.

The “settings for entire document” window 900 is called from a “settings for entire document” menu in a “print settings menu” illustrated in FIG. 7 or “settings for entire document” button on the toolbar. The user can execute setting of an attribute that may be effective for the entire document via the “settings for entire document” window 900.

The “settings for entire document” window 900 includes six sheets, namely, a “paper settings” sheet, a “page setup” sheet, a “finishing” sheet, an “edit” sheet, a “paper source” sheet, and a “quality” sheet. In the example illustrated in FIG. 9, the “paper settings” sheet is displayed. In the “paper settings” sheet, the user can primarily execute a setting related to the layout (imposition). More specifically, the user can issue an instruction for setting the output paper size and the output paper orientation.

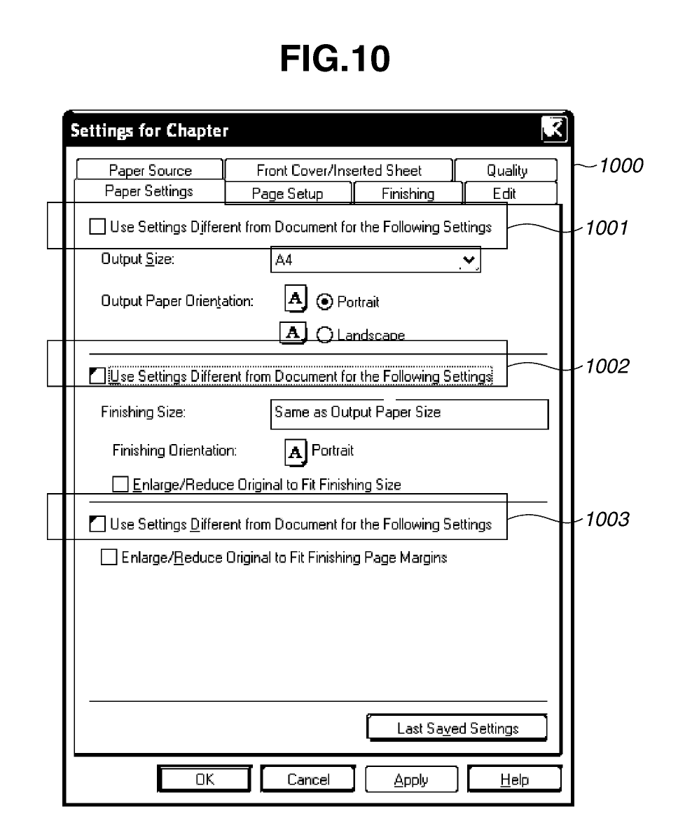

FIG. 10 illustrates an example of a “settings for chapter” window 1000 of the bookbinding application 104 according to the present exemplary embodiment.

In the “settings for chapter” window 1000, the user can display and set the chapter setting information 307. The “settings for chapter” window 1000 is called from a “settings for chapter” menu in the “print settings menu” in FIG. 7 or “settings for chapter” button on the toolbar. The user can execute setting of an attribute unique to a chapter via the “settings for chapter” window 1000.

The “settings for chapter” window 1000 includes seven sheets such as a “paper settings” sheet, a “page setup” sheet, a “finishing” sheet, an “edit” sheet, a “paper source” sheet, a “front cover/inserted sheet” sheet, and a “quality” sheet.

In the example illustrated in FIG. 10,l the “paper settings” sheet is displayed. The user can primarily execute a setting for a sheet, which can be set uniquely for each chapter via the “paper settings” sheet. More specifically, the user can issue an instruction for setting the output paper size, the output paper orientation, and the finishing size via the “paper settings” sheet.

“Use settings different from document for the following settings” check boxes 1001 through 1003 can be checked by the user to execute setting of setting items that can be set in common with the settings for the entire document and the settings for a chapter. With respect to items whose corresponding check box 1001, 1002, or 1003 has been checked, a value set via the “settings for chapter” window 1000 is applied to the corresponding chapter instead of applying a setting value set for the document.

The settings that can be uniquely set for a chapter can be classified into two types. One type is a setting item that can be set for a chapter only. The other is a setting item for a chapter that has a specific setting value different from that for a document, which is an upper layer thereof.

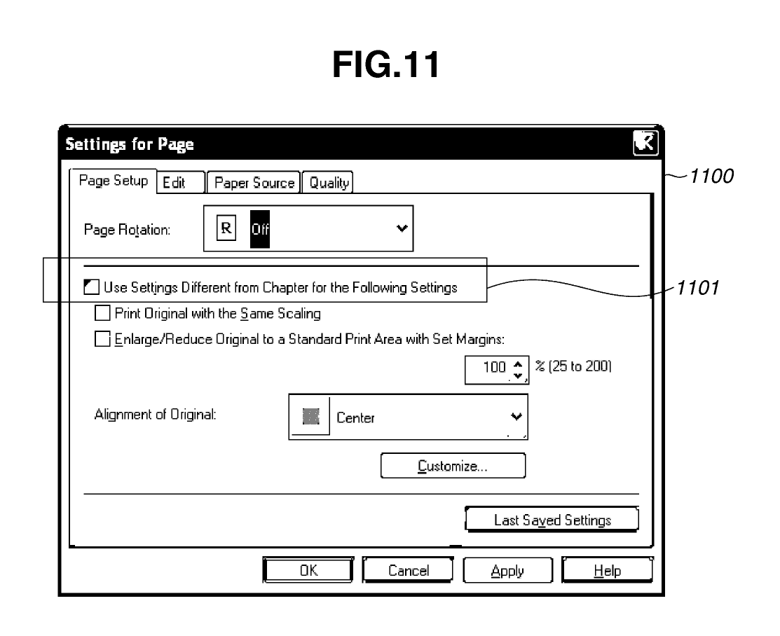

FIG. 11 illustrates an example of a “settings for page” window 1100 of the bookbinding application 104 according to the present exemplary embodiment. The user can display and set the page setting information 311 via the “settings for page” window 1100.

The window is called by pressing a “settings for page” button on a “settings for page” menu in the “print settings” menu or on a tool bar displayed on the application operation screen 700 (FIG. 7).

The “settings for page” window 1100 is a window for setting an attribute uniquely set for each page. The “settings for page” window 1100 includes four sheets such as a “page setup” sheet, an “edit” sheet, a “paper source” sheet, and a “quality” sheet. In the example illustrated in FIG. 11, the “page setup” sheet is displayed.

The user can primarily execute a setting of a layout (imposition) uniquely set for each page via the “settings for page” window 1100. More specifically, the user can issue an instruction for setting a rotational angle and an enlargement/reduction ratio of an original page to be imposed on the printing sheet.

A “use settings different from chapter for the following settings” check box 1101 can be checked by the user to execute setting of setting items that can be set in common with the settings for a chapter and the settings for a page. With respect to the setting item whose “use settings different from chapter for the following settings” check box 1101 is not checked, the setting value for a chapter is applied to the page.

The control information for the “use settings different from chapter for the following settings” check box 1101, which is set by the user via the “settings for page” window 1100, maybe stored in a previously provided dedicated storage area. It is more useful if the control information for the “use settings different from chapter for the following settings” check box 1101 is stored within the setting information illustrated in FIG. 3 as one of the attributes. In this case, the examples illustrated in FIGS. 5 and 6 additionally include an area for storing the control information for the “use settings different from chapter for the following settings” check box 1101.

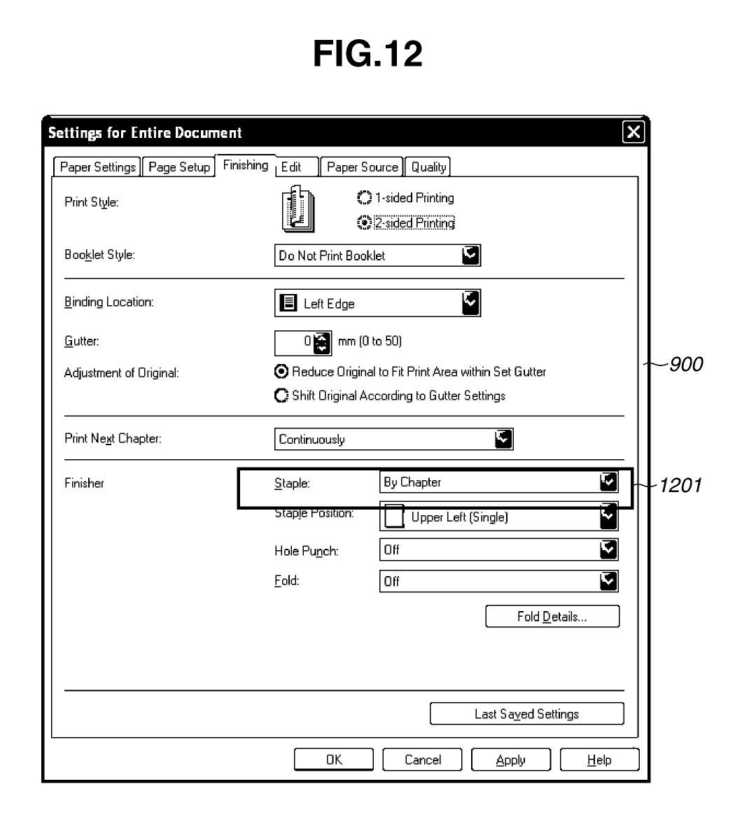

FIG. 12 illustrates an example of a display on the “settings for entire document” window 900 of the bookbinding application 104, in which the user has designated the setting for executing stapling processing. Referring to FIG. 12, a “staple” combo box 1201 of the “finishing” sheet includes four alternatives, namely, “off”, “all page at once”, “by chapter”, and “auto mode”.

If “off” is selected, then “disable stapling” is set. If “all pages at once” is selected, then “staple by copy” is set. If “by chapter” is selected, then “staple by chapter” is set. If “auto mode” is selected, then stapling in the auto staple mode, which will be described in detail below, can be set and executed.

In the example illustrated in FIG. 12, the user has opened (designated) the “finishing” sheet and has set “by chapter” stapling as the setting for the item “staple”.

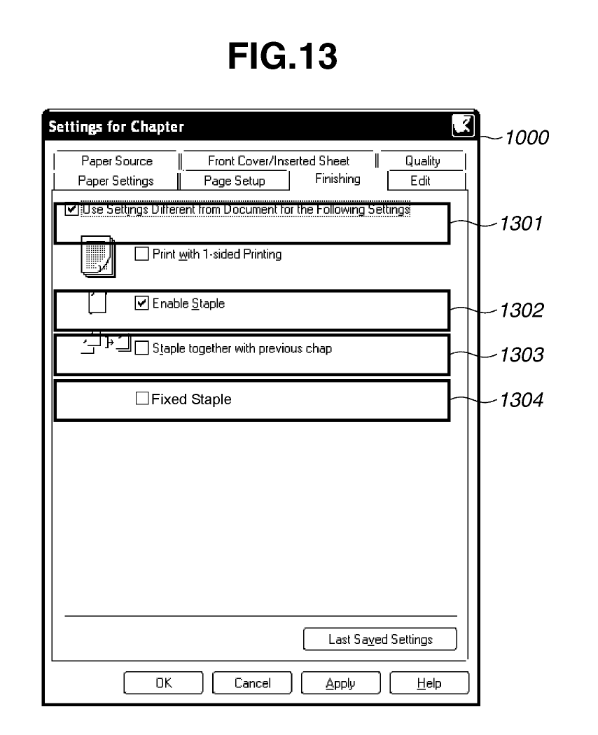

FIG. 13 illustrates the “settings for chapter” window 1000 of the bookbinding application 104 called by the user, in which stapling of a chapter is set by the user. In the example illustrated in FIG. 13, a “use settings different from document for the following settings” check box 1301 of the “finishing” sheet is checked. Accordingly, a setting unique to the chapter can be set.

The user can enable (disable) an “enable staple” check box 1302 to execute (not to execute) stapling of the chapter. In addition, the user can enable (disable) a “staple together with previous chapter” check box 1303 to execute (not to execute) stapling together with a previous chapter.

Furthermore, the user can enable (disable) a “fixed staple” check box 1304 to give an instruction for preferentially processing (not for preferentially processing) the state set by checking the check box 1302 or the check box 1303 in the auto staple mode.

If the check box 1302 is checked for a first chapter and if the check box 1302 is checked for a second chapter while the check box 1303 is not checked for the second chapter, then the first and the second chapters are stapled as different staple sets.

Furthermore, if the check box 1302 is checked for the first chapter and both the check boxes 1302 and 1303 are checked for the second chapter, then the first and the second chapters are stapled as one staple set. Furthermore, in this case, if both the check boxes 1302 and 1303 are checked for subsequent chapters, then the first, the second, and the subsequent chapters are stapled as one staple set.

If the check box 1302 is not checked for the first chapter and if the check box 1303 is checked for the second chapter, the first and the second chapters cannot be stapled as one staple set because the first chapter is not designated to be stapled.

Accordingly, the check box 1303 may not be effective if the setting of stapling for a previous chapter is not enabled. Therefore, if stapling is not designated to be executed on a previous chapter or if the chapter is a first chapter, which has no previous chapter, it is useful if the bookbinding application 104 disables the check box 1303.

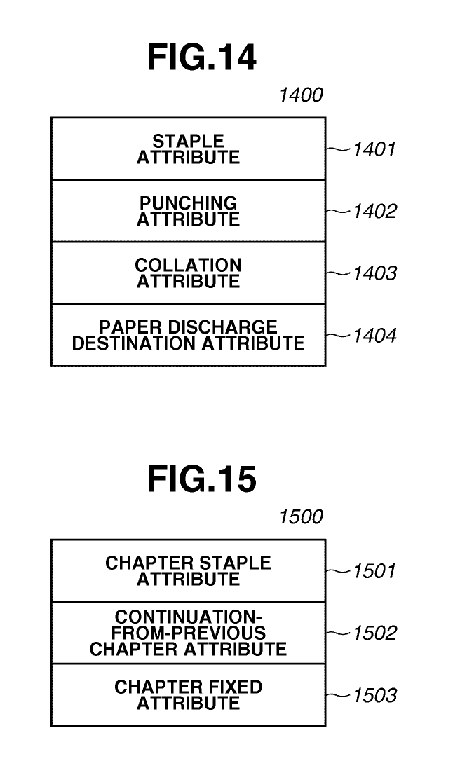

FIG. 14 illustrates an example of a further detailed format of a paper discharge attribute of the book attribute (the document setting information 303) illustrated in FIG. 4.

Referring to FIG. 14, a paper discharge attribute 1400 includes four attributes, such as a staple attribute 1401, a punching attribute 1402, a collation attribute 1403, and a paper discharge destination attribute 1404.

The staple attribute 1401 can include four attribute values, such as “staple off”, “staple entire document”, “staple by chapter”, and an “auto staple mode”. If stapling is enabled, the staple attribute 1401 can further include an attribute of location of staple, such as “staple at one upper-right location”, “staple at two locations on right edge portion of sheet bundle”, or “staple at one lower-right location”. The staple attribute 1401 further includes the number of staplable sheets as one of the staple attributes.

The punching attribute 1402 can include attribute values, such as “punching enabled (ON)” or “punching disabled”. If punching is enabled, the punching attribute 1402 can additionally include a sub attribute for the number of punching holes.

The collation attribute 1403 can include two attribute values, such as “print copy by copy” or “print in page by page”. The paper discharge destination attribute 1404 includes a paper discharge port identification (ID), which uniquely identifies a paper discharge port.

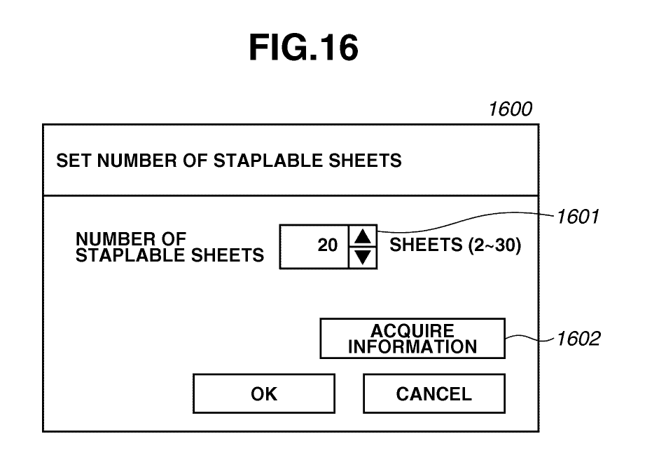

FIG. 15 illustrates an example of a data structure of paper discharge destination attribute 1500 included in a chapter attribute (the chapter setting information 307).

The chapter paper discharge destination attribute 1500 includes a chapter staple attribute 1501, a continuation-from-previous chapter attribute 1502, and a chapter fixed attribute 1503. The chapter staple attribute 1501 stores any of setting values, such as “staple enabled (ON)”, “staple disabled”, and “divide within chapter”.

The continuation-from-previous chapter attribute 1502 stores a setting value for setting whether to staple a current chapter together with the previous chapter. The chapter fixed attribute 1503 stores a setting value for setting whether to preferentially process the setting set in the current chapter staple attribute 1501 and the continuation-from-previous chapter attribute 1502 in the auto staple mode. The attributes illustrated in FIG. 15 correspond to staple GUI controls 1302 through 1304 (FIG. 13), respectively.

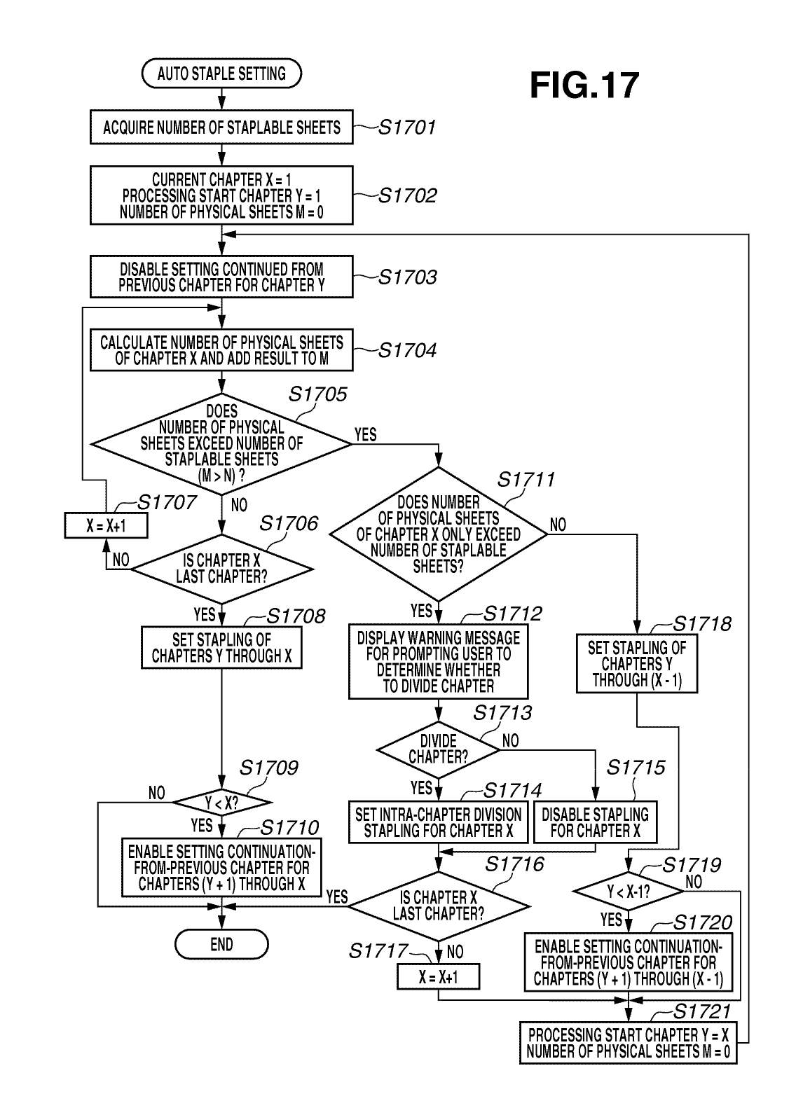

FIG. 16 illustrates an example of a “number of staplable sheets” setting dialog of the bookbinding application 104. The number of staplable sheets-setting dialog is controlled by the CPU 201 of the host computer 100 to be displayed on the CRT 210.

A “number of staplable sheets” spin box 1601 can be operated by the user to enter and display the number of staplable sheets. The user can directly enter a numerical value in the “number of staplable sheets” spin box 1601. In addition, the user can click an “increase” spin button or a “decrease” spin button of the “number of staplable sheets” spin box 1601 to change the input value. A default value of the number of staplable sheets can be uniquely managed by the bookbinding application 104. It is also useful if the bookbinding application 104 manages a number of staplable sheets default value for each printer driver 106.

When the user clicks an information acquisition button 1602, the CPU 201 acquires the number of staplable sheets from the printer 107 via the interactive interface 21. The acquired information is reflected as the value of the “number of staplable sheets” spin box 1601 on the screen.

When the user clicks the OK button, the value displayed in the “number of staplable sheets” spin box 1601 is stored on the RAM 202, for example, as the number of staplable sheets included in the staple attribute 1401. In the present exemplary embodiment, the number of staplable sheets is acquired from the printer 107. Accordingly, the present exemplary embodiment can enable the user to set an optimum number of staplable sheets.

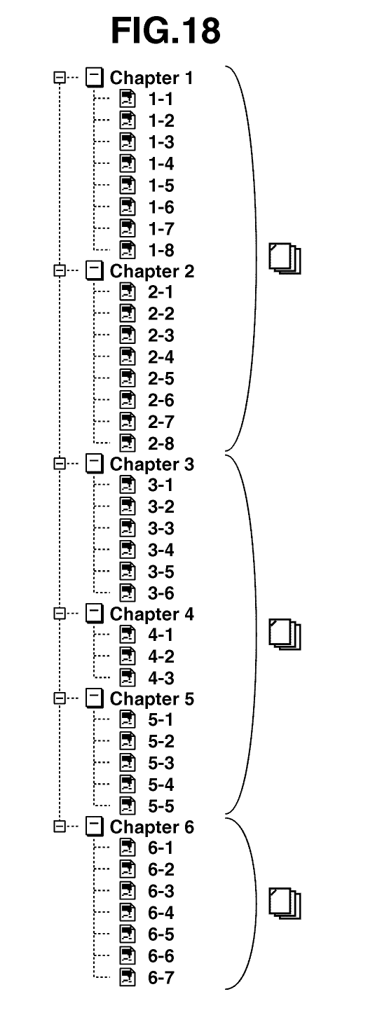

FIG. 17 is a flow chart illustrating an example of processing for automatically executing a staple setting according to the present exemplary embodiment. Processing in each step of the flow chart of FIG. 17 is implemented and executed by the CPU 201 of the host computer 100.

When the user clicks the “auto staple” button 703 (FIG. 7), the processing for automatically setting a staple setting illustrated in FIG. 17 starts. Referring to FIG. 17, in step S1701, the CPU 201 sets the number of staplable sheets (N). The setting of the number of staplable sheets N can be implemented by setting the value stored in the number of staplable sheets-field of the staple attribute 1401 (FIG. 14) via the number of staplable sheets-setting dialog 1600 (FIG. 16).

It is also useful if the CPU 201 acquires the number of staplable sheets from the printer 107 via the interactive interface 21 when the processing illustrated in FIG. 17 starts. In this case, the CPU 201 sets the acquired value as the number of staplable sheets N and stores the acquired value in the number of staplable sheets field of the staple attribute 1401 at the same time.

In step S1702, the CPU 201 initializes each variable. Furthermore, in step S1702, the CPU 201 sets a value “1” as a value of a current chapter (X) and a processing start chapter (Y). In addition, the CPU 201 sets a value “0” as a physical number of pages (M). The variables set in the above-described manner are stored on the RAM 202.

In step S1703, the CPU 201 disables (“OFF”) the continuation-from-previous chapter attribute 1502 of the processing start chapter Y. In step S1704, the CPU 201 calculates the physical number of pages of the current chapter X and adds the result of the calculation to the physical number of pages M. By executing the above-described processing, the total number of physical pages of chapters from the processing start chapter Y to the current chapter X can be stored as the physical number of pages M.

In step S1705, the CPU 201 determines whether the physical number of pages M is larger than the number of staplable sheets N. If it is determined that the physical number of pages M is equal to or smaller than the number of staplable sheets N (NO in step S1705), then the processing advances to step S1706. On the other hand, if it is determined that the physical number of pages M is larger than the number of staplable sheets N (YES in step S), then the processing advances to step S1711. The CPU 201 determines a location at which the staple target is divided based on the result of determination in step S1705.

In step S1706, the CPU 201 determines whether the current chapter X is the last chapter. If it is determined that the current chapter X is not the last chapter (NO in step S1706), then the processing advances to step S1707. On the other hand, if it is determined that the current chapter X is the last chapter (YES in step S1706), then the processing advances to step S1708.

In step S1707, the CPU 201 increments the value X of the current chapter number by 1. Then, the processing advances to step S1704. In step S1708, since the processing on the last chapter has been completed, the CPU 201 sets the parameter value “staple enabled (ON)” to the chapter staple attribute 1501 of all chapters from the processing start chapter Y to the current chapter X.

In step S1709, the CPU 201 determines whether the value Y of the processing start chapter is smaller than the value X of the current chapter number. If it is determined that the value Y of the processing start chapter is smaller than the value X of the current chapter number (YES in step S1709), then the processing advances to step S1710. On the other hand, if it is determined that the value Y of the processing start chapter is equal to or greater than the value X of the current chapter number (NO in step S1709), then the processing illustrated in FIG. 17 ends.

In step S1710, the CPU 201 sets a parameter value “ON” to the continuation-from-previous chapter attribute 1502 of all the chapters from a (processing start chapter Y+1)-th chapter to the current chapter X. Then, the processing illustrated in FIG. 17 ends.

In step S1711, the CPU 201 determines whether the physical number of pages M of only one chapter exceeds the number of staplable sheets N. More specifically, the determination in step S1711 can be executed based on whether the value Y of the processing start chapter and the value X of the current chapter number are the same.

If it is determined that the value Y of the processing start chapter and the value X of the current chapter number are the same (that the physical number of pages M of only one chapter exceeds the number of staplable sheets N) (YES in step S1711), then the processing advances to step S1712. On the other hand, if it is determined that the value Y of the processing start chapter and the value X of the current chapter number are not the same (that the physical number of pages M of only one chapter does not exceed the number of staplable sheets N) (NO in step S1711), then the processing advances to step S1718.

The CPU 201 determines a location, at which the staple target is divided, based on the result of determination in step S1711. In step S1712, the CPU 201 displays a verification message that prompts the user to determine whether to divide the chapter. In step S1713, the CPU 201 determines whether to divide the chapter.

More specifically, it is useful if the CPU 201 executes the processing in steps S1712 by executing control for displaying a dialog message, such as “Divide-staple chapter X?” to prompt the user to determine whether to divide the chapter X before stapling the same. If it is determined that the current chapter X is to be divided according to the user operation (YES in step S1713), then the processing advances to step S1714. In step S1714, the CPU 201 sets a parameter value “divide chapter” as the value of the chapter staple attribute 1501 of the current chapter X.

In the present exemplary embodiment, in dividing a chapter, it is useful to divide the chapter by each bundle of N staplable sheets. It is also useful if the chapter is evenly divided by every arbitrary number of sheets within the number of staplable sheets N. By executing the above-described processing, the processing can be appropriately executed even if the number of sheets necessary for only one chapter is greater than the number of staplable sheets N.

If it is determined that the chapter is not to be divided (NO in step S1713), then the processing advances to step S1715. In step S1715, the CPU 201 sets the parameter value “staple OFF” to the chapter staple attribute 1501 of the current chapter X.

In step S1716, the CPU 201 determines whether the current chapter X is the last chapter. If it is determined that the current chapter X is not the last chapter (NO in step S1716), then the processing advances to step S1717. On the other hand, if it is determined that the current chapter X is the last chapter (YES in step S1716), then the processing illustrated in FIG. 17 ends.

In step S1717, the CPU 201 increments the value X of the current chapter number by 1. In this case, the processing advances to step S1721. In step S1718, the CPU 201 sets the parameter value “staple ON” to the chapter staple attribute 1501 of all the chapters from the processing start chapter Y to a ((current chapter number) X−1)-th chapter.

In step S1719, the CPU 201 determines whether the value Y of the processing start chapter is smaller than the value (X−1) of the chapter previous to the current chapter. If it is determined that the value Y of the processing start chapter is smaller than the value (X−1) of the chapter previous to the current chapter (YES in step S1719), then the processing advances to step S1720. On the other hand, if it is determined that the value Y of the processing start chapter is equal to or greater than the value (X−1) of the chapter previous to the current chapter (NO in step S1719), then the processing advances to step S1721.

In step S1720, the CPU 201 sets the parameter value “ON” to the continuation-from-previous chapter attribute 1502 of all the chapters from a chapter immediately subsequent to the processing start chapter Y (i.e., a (Y+1)-th chapter) to a chapter immediately previous to the current chapter X (i.e., an (X−1)-th chapter), and then the processing advances to step S1721. In step S1721, the CPU 201 sets the current chapter X as the processing start chapter Y and sets a value “0” to the physical number of pages M. Then, the processing returns to step S1703.

By executing the above-described processing, the present exemplary embodiment can automatically execute staple division location auto setting based on the number of staplable sheet. Accordingly, the present exemplary embodiment can prevent inconsistency between the staple setting and the actual number of stapled sheets of a resulting print product.

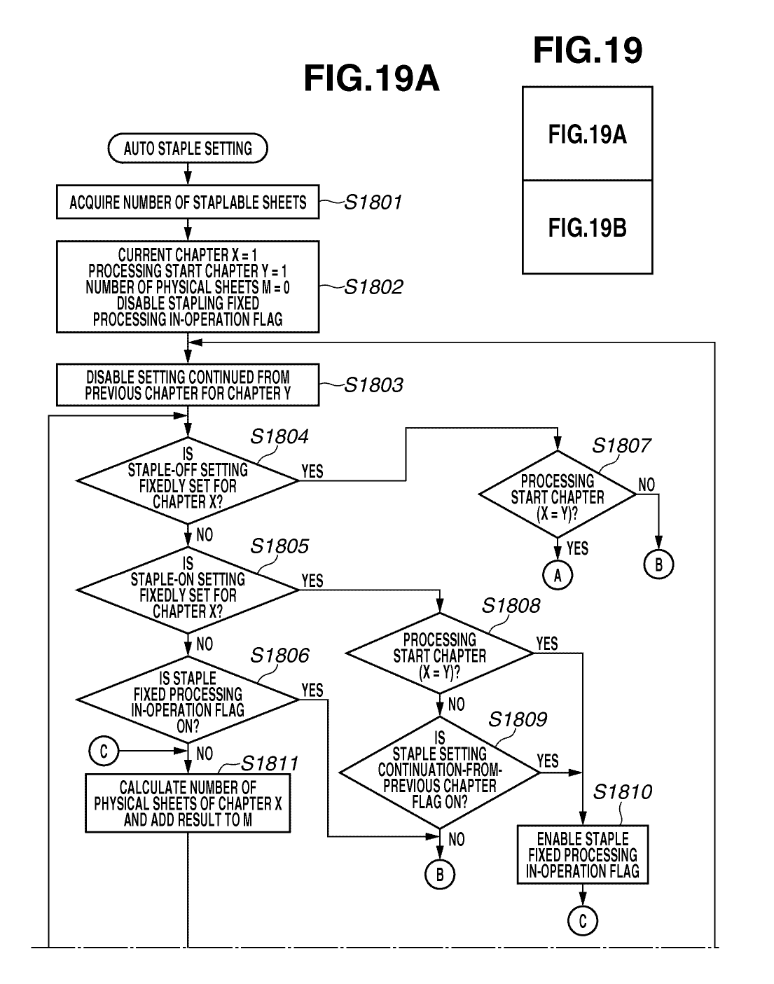

FIG. 18 illustrates an example of a list of results of the staple automatic setting processing illustrated in FIG. 17 according to the present exemplary embodiment. The staple automatic setting processing result list screen is controlled by the CPU 201 of the host computer 100 to be displayed on the CRT 210.

More specifically, the staple automatic setting processing result list is displayed in the tree structure field 701, which is displayed on the UI screen 700 of the bookbinding application 104. In the present exemplary embodiment, the document file includes six chapters in total (chapters 1 through 6). The physical number of sheets of each chapter is eight (chapter 1), eight (chapter 2), six (chapter 3), three (chapter 4), five (chapter 5), and seven (chapter 6).

If the number of staplable sheets N of the document file described above is twenty and if the staple automatic setting processing illustrated in FIG. 17 is executed for the document file, then the chapters 1 and 2 are stapled together and the chapters 3 through 5 are stapled together as one bundle while the chapter 6 is stapled as one bundle.

In this case, the parameter value “staple ON” is set to the chapter staple attribute 1501 of all the chapters, and the parameter value “ON” is set to the continuation-from-previous chapter attribute 1502 of the chapters 2, 4, and 5. The present exemplary embodiment displays the list of results in the tree structure field 701 of the UI screen 700 of the bookbinding application 104 in the above-described manner. Accordingly, the user can browse and recognize the setting more easily. Thus, the present exemplary embodiment can improve the usability.

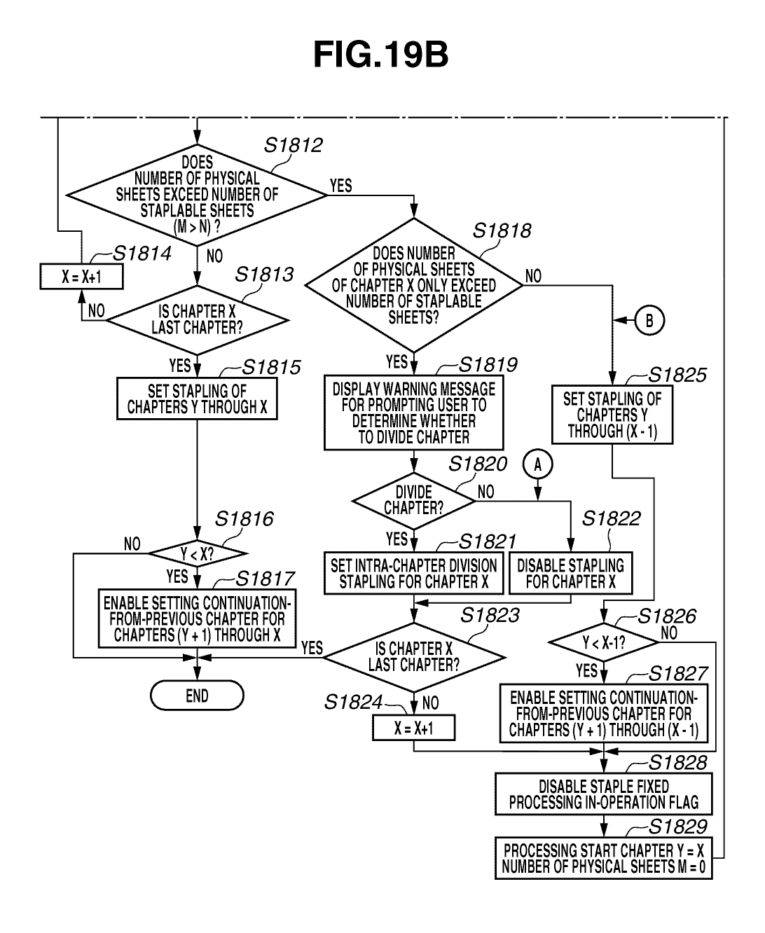

FIG. 19 is a flow chart illustrating an example of processing for automatically executing a staple setting according to a second exemplary embodiment of the present invention. Processing in each step of the flow chart of FIG. 19 is implemented and executed by the CPU 201 of the host computer 100.

When a user clicks the “auto staple” button 703 (FIG. 7), the processing for automatically setting a staple setting illustrated in FIG. 17 starts as in the first exemplary embodiment. Referring to FIG. 19, in step S1801, the CPU 201 sets the number of staplable sheets (N) by executing the processing similar to that in step S1701 (FIG. 17).

In step S1802, the CPU 201 initializes each variable. Furthermore, in step S1802, the CPU 201 sets a value “1” as a value of a current chapter (X) and a processing start chapter (Y). In addition, the CPU 201 sets a value “0” as a physical number of pages (M). In addition, the CPU 201 sets a parameter value “OFF (disabled)” to a stapling fixed processing in-operation flag. The variables set in the above-described manner are stored on the RAM 202. In step S1803, the CPU 201 disables (“OFF”) the continuation-from-previous chapter attribute 1502 of the processing start chapter Y.

In step S1804, the CPU 201 determines whether the parameter value “staple OFF” is fixedly set to the current chapter X. The determination in step S1804 can be executed based on whether the parameter value “ON” is set to the chapter fixed attribute 1503 of the current chapter X and whether the parameter value “staple OFF” is set to the chapter staple attribute 1501 of the current chapter X.

If it is determined that the parameter value “staple OFF” is fixedly set to the current chapter X (YES in step S1804), then the processing advances to step S1807. On the other hand, if it is determined that the parameter value “staple OFF” is not fixedly set to the current chapter X (NO in step S1804), then the processing advances to step S1805.

In step S1805, the CPU 201 determines whether the parameter value “staple ON” is fixedly set to the current chapter X. The determination in step S1805 can be executed based on whether the parameter value “ON” is set to the chapter fixed attribute 1503 of the current chapter X and whether the parameter value “staple ON” is set to the chapter staple attribute 1501 of the current chapter X.

If it is determined that the parameter value “staple ON” is fixedly set to the current chapter X (YES in step S1805), then the processing advances to step S1808. On the other hand, if it is determined that the parameter value “staple ON” is not fixedly set to the current chapter X (NO in step S1805), then the processing advances to step S1806.

In step S1806, the CPU 201 determines whether the stapling fixed processing in-operation flag is set ON. If it is determined that the stapling fixed processing in-operation flag is set ON (YES in step S1806), then the processing advances to step S1825. On the other hand, if it is determined that the stapling fixed processing in-operation flag is set OFF (NO in step S1806), then the processing advances to step S1811.

In step S1807, the CPU 201 starts processing executed when the staple processing is fixedly set OFF. More specifically, in step S1807, the CPU 201 determines whether the value X of the current chapter number is equal to the value Y of the processing start chapter. If it is determined that the value X of the current chapter number is equal to the value Y of the processing start chapter (YES in step S1807), then the processing advances to step S1822. On the other hand, if it is determined that the value X of the current chapter number is different from the value Y of the processing start chapter (NO in step S1807), then the processing advances to step S1825 because it is necessary to execute stapling on chapters up to the previous chapter.

In step S1808, the CPU 201 starts processing executed when the staple processing is fixedly set ON. More specifically, in step S1808, the CPU 201 determines whether the value X of the current chapter is equal to the value Y of the processing start chapter. If it is determined that the value X of the current chapter is equal to the value Y of the processing start chapter (YES in step S1808), then the processing advances to step S1810. On the other hand, if it is determined that the value X of the current chapter is different from the value Y of the processing start chapter (NO in step S1808), then the processing advances to step S1809.

In step S1809, the CPU 201 determines whether the parameter value “ON” is set to the continuation-from-previous chapter attribute 1502 of the current chapter X. If it is determined that the parameter value “ON” is set to the continuation-from-previous chapter attribute 1502 of the current chapter X (YES in step S1809), then the processing advances to step S1810. On the other hand, if it is determined that the parameter value “ON” is not set to the continuation-from-previous chapter attribute 1502 of the current chapter X (NO in step S1809), then the processing advances to step S1825 because, in this case, the sheet bundle of the document corresponding to chapters up to the previous chapter are stapled together and the bundle of sheets of the document corresponding to the current chapter X (and beyond) are to be separately stapled (i.e., because the stapling not continuous with the previous chapter sheets is to be executed).

In step S1810, the CPU 201 sets the parameter value “ON” to the stapling fixed processing in-operation flag. Then, the processing advances to step S1811. Processing in steps S1811 through S1827 can be implemented by executing processing similar to that in steps S1704 through S1720 (FIG. 17). Accordingly, the description thereof will not be repeated here.

In step S1828, the CPU 201 sets the parameter value “OFF” to the stapling fixed processing in-operation flag. Then, the processing advances to step S1829. In step S1829, the CPU 201 sets the current chapter X as the processing start chapter Y and sets the parameter value “0” to the physical number of pages M. Then, the processing returns to step S1803.

By executing the above-described processing, divided stapling setting can be performed after preferentially setting a chapter for which stapling is fixedly set “ON” or “OFF”. Accordingly, the present exemplary embodiment can further improve the usability.

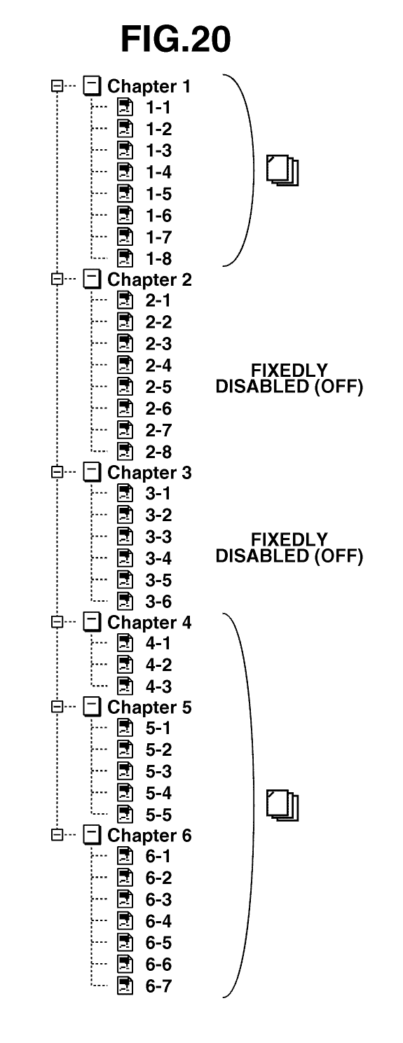

FIG. 20 illustrates an example (case 1) of a list of results of the staple automatic setting processing illustrated in FIG. 19. The staple automatic setting processing result list (case 1) is displayed on the CRT 210 under control of the CPU 201 of the host computer 100.

More specifically, the staple automatic setting processing result list (case 1) is displayed in the tree structure field 701, which is displayed on the UI screen 700 of the bookbinding application 104. In the example illustrated in FIG. 20, the document file includes six chapters in total (chapters 1 through 6) as in the example illustrated in FIG. 18. The physical number of sheets of each chapter is eight (chapter 1), eight (chapter 2), six (chapter 3), three (chapter 4), five (chapter 5), and seven (chapter 6).

In the example illustrated in FIG. 20, the parameter “staple OFF” is fixedly set to the chapters 2 and 3. More specifically, the parameter value “ON” is set to the chapter fixed attribute 1503 while the parameter value “staple OFF” is set to the chapter staple attribute 1501.

If the number of staplable sheets N of the document file described above is twenty and if the staple automatic setting processing illustrated in FIG. 19 is executed for the document file, then the chapter 1 is to be stapled as one sheet bundle while the chapters 2 and 3 are stapled together and the chapters 4 through 6 are stapled together as one sheet bundle. Furthermore, the parameter value “staple ON” is set to the chapter staple attribute 1501 of the chapters 4 through 6 and the parameter value “ON” is set to the continuation-from-previous chapter attribute 1502 of the chapters 5 and 6.

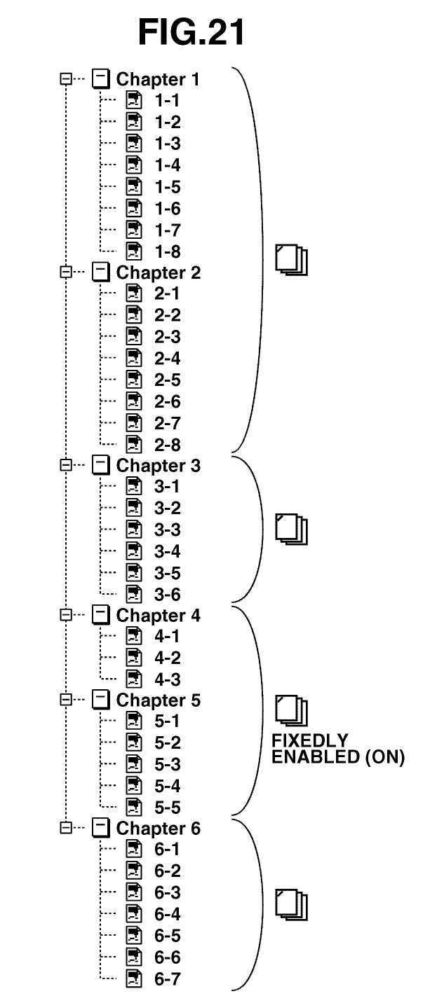

FIG. 21 illustrates an example (case 2) of a list of results of the staple automatic setting processing illustrated in FIG. 19. The staple automatic setting processing result list (case 2) is displayed on the CRT 210 under control of the CPU 201 of the host computer 100.

More specifically, the staple automatic setting processing result list (case 2) is displayed in the tree structure field 701, which is displayed on the UI screen 700 of the bookbinding application 104. In the example illustrated in FIG. 21, the document file includes six chapters in total (chapters 1 through 6) as in the example illustrated in FIG. 20. The physical number of sheets of each chapter is eight (chapter 1), eight (chapter 2), six (chapter 3), three (chapter 4), five (chapter 5), and seven (chapter 6).

More specifically, in the example illustrated in FIG. 21, the parameter value “staple ON” is fixedly set for the chapters 4 and 5, i.e., the parameter value “ON” is set to the chapter fixed attribute 1503 of the chapters 4 and 5, the parameter value “staple ON” is set to the chapter staple attribute 1501 of the chapters 4 and 5, and the parameter value “ON” is set to the continuation-from-previous chapter attribute 1502 of the chapter 5.

If the number of staplable sheets N of the document file described above is twenty and if the staple automatic setting processing illustrated in FIG. 19 is executed for the document file, then the chapters 1 and 2 are stapled as one sheet bundle, the chapter 3 is stapled as another sheet bundle, the chapters 4 and 5 are stapled as yet another sheet bundle, and the chapter 6 is stapled as yet another sheet bundle.

Furthermore, the parameter value “staple ON” is set to the chapter staple attribute 1501 of all the chapters and the parameter value “ON” is set to the continuation-from-previous chapter attribute 1502 of the chapters 2 and 5. By displaying the processing result list in the tree structure field 701 included in the UI screen 700 of the bookbinding application 104 as described above with reference to FIGS. 20 and 21, the user can easily recognize the setting. Accordingly, the present exemplary embodiment can improve the usability.

With each of the above-described configurations, the user can automatically set the divided staple setting based on the number of staplable sheets while the user is inhibited from setting stapling of the number of sheets exceeding that of staplable sheets as one sheet bundle. Accordingly, each exemplary embodiment of the present invention can prevent inconsistency between the staple setting and the staple status of a resulting print product. In addition, according to an exemplary embodiment of the present invention, the user can execute the divided staple setting on chapters after preferentially setting a chapter for which stapling is fixedly set “ON” or “OFF”. Accordingly, each exemplary embodiment of the present invention can further improve the usability.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention is described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-061682 filed Mar. 13, 2009, which is hereby incorporated by reference herein in its entirety.

What is claimed is:

1. An apparatus comprising:
an instruction unit configured to give an instruction for executing divided stapling;
an acquisition unit configured, when the instruction is given, to acquire a number of staplable sheets;
a determination unit configured to determine a location at which the divided stapling is executed based on the acquired number of staplable sheets and a number of sheets necessary for each chapter; and
a staple setting unit configured to set a staple attribute for instructing a printing apparatus to execute stapling by using the determined location as a unit of the divided stapling.

2. The apparatus according to claim 1, further comprising a first preferential setting unit configured to preferentially set a chapter not to be stapled, wherein the location is determined based on the chapter not to be stapled.

3. The apparatus according to claim 1, further comprising a second preferential setting unit configured to preferentially set a chapter to be stapled, wherein the location is determined based on the chapter to be stapled.

4. The apparatus according to claim 1, further comprising:
a second determining unit configured to determines whether a number of sheets necessary for one chapter is greater than the number of staplable sheets based on the acquired number of staplable sheets and the number of sheets necessary for each chapter; and
a verification unit configured, if it is determined that number of sheets necessary for one chapter is greater than the number of staplable sheets, to prompt a user to designate whether to execute the divided stapling for the chapter.

5. The apparatus according to claim 1, further comprising a display unit configured to display a list of results of the executed stapling.

6. The apparatus according to claim 1, wherein the acquisition unit is configured to acquire the number of staplable sheets according to a user operation.

7. The apparatus according to claim 1, wherein the acquisition unit is configured to acquire the number of staplable sheets from the printing apparatus.

8. A method comprising:
instructing an apparatus to execute divided stapling;
acquiring, when the instructing for executing divided stapling is given, a number of staplable sheets;
determining a location at which the divided stapling is executed based on the acquired number of staplable sheets and a number of sheets necessary for each chapter; and
setting a staple attribute for instructing a printing apparatus to execute stapling by using the determined location as a unit of the divided stapling.

9. The method according to claim 8, further comprising:
preferentially setting a chapter not to be stapled, wherein the
determining the location is further based on the preferentially set chapter not to be stapled.

10. The method according to claim 8, further comprising:
preferentially setting a chapter to be stapled, wherein
the determining the location is further based on the preferentially set chapter to be stapled.

11. The method according to claim 8, further comprising:
determining whether a number of sheets necessary for one chapter is greater than the number of staplable sheets based on the acquired number of staplable sheets and the number of sheets necessary for each chapter; and
executing verification, if it is determined that the number of sheets necessary for one chapter is greater than the number of staplable sheets, for prompting a user to designate whether to execute the divided stapling for the chapter.

12. The method according to claim 8, further comprising displaying a list of results of the executed stapling.

13. The method according to claim 8, wherein acquiring the number of staplable sheets is in accordance to a user operation.

14. The method according to claim 8, wherein acquiring the number of staplable sheets is from the printing apparatus.

15. A computer-readable storage medium storing computer-executable instructions which, when executed by a computer, cause the computer to perform a method, the method comprising:
instructing an apparatus to execute divided stapling;
acquiring, when the instruction for executing divided stapling is given, a number of staplable sheets;
determining a location at which the divided stapling is executed based on the acquired number of staplable sheets and a number of sheets necessary for each chapter; and
setting a staple attribute for instructing a printing apparatus to execute stapling by using the determined location as a unit of the divided stapling.

16. The computer-readable storage medium according to claim 15, further comprising:
preferentially setting a chapter not to be stapled, wherein the determining the location is further based on the preferentially set chapter not to be stapled.

17. The computer-readable storage medium according to claim 15, further comprising:
preferentially setting a chapter to be stapled, wherein
the determining the location is further based on the preferentially set chapter to be stapled.

18. The computer-readable storage medium according to claim 15, further comprising:
determining whether a number of sheets necessary for one chapter is greater than the number of staplable sheets based on the acquired number of staplable sheets and the number of sheets necessary for each chapter; and
executing verification, if it is determined that the number of sheets necessary for one chapter is greater than the number of staplable sheets, for prompting a user to designate whether to execute the divided stapling for the chapter.

19. The computer-readable storage medium according to claim 15, further comprising displaying a list of results of the executed stapling.

20. The computer-readable storage medium according to claim 15, wherein acquiring the number of staplable sheets is in accordance to a user operation.
